(19) United States
(12) Patent Application Publication
(10) Pub. No.: US 2025/0108348 A1
(43) Pub. Date: Apr. 3, 2025

(54) MULTI-TIERED DISPERSION ADAPTER FOR CONVEYOR PROPPANT DELIVERY SYSTEMS

(71) Applicant: STEWART & STEVENSON LLC, Houston, TX (US)

(72) Inventor: Harrison SMITH, Houston, TX (US)

(21) Appl. No.: 18/896,141

(22) Filed: Sep. 25, 2024

Related U.S. Application Data
(60) Provisional application No. 63/541,469, filed on Sep. 29, 2023.

(51) Int. Cl. B01F 35/00; B01F 23/50; B01F 35/71; B01F 101/49; E21B 43/26

(52) U.S. Cl. CPC B01F 35/55; B01F 23/59; B01F 35/71731; E21B 43/2607; B01F 2101/49

(57) ABSTRACT

A blender system includes a blender tub, the blender tub defining a mixing chamber, an interior, and an upper opening. In addition, the blender system includes one or more blender paddles positioned within the mixing chamber. Further, the blender system includes a multi-tiered dispersion adapter positioned within the blender tub, the multi-tiered dispersion adapter including plates arranged at an angle to a horizontal plane of the blender tub's upper opening.

### CROSS-REFERENCE TO RELATED APPLICATIONS

This application is a nonprovisional application which claims priority from U.S. provisional application No. 63/541,469, filed Sep. 29, 2023, which is incorporated by reference herein in its entirety.

### TECHNICAL FIELD/FIELD OF THE DISCLOSURE

The present disclosure relates generally to well service equipment and specifically to equipment used with well fluids.

### BACKGROUND OF THE DISCLOSURE

During drilling, completion, and production operations, fluids are circulated through a wellbore. Various chemicals and materials are introduced into the fluids, referred to herein as the slurry, to produce slurries having desirable characteristics. Examples of chemicals and materials include dry proppants, such as sand, as well as fluids and gels.

### SUMMARY

A blender system is disclosed. The blender system includes. a blender tub, the blender tub defining a mixing chamber, an interior, and an upper opening. In addition, the blender system includes one or more blender paddles positioned within the mixing chamber. Further, the blender system includes a multi-tiered dispersion adapter positioned within the blender tub, the multi-tiered dispersion adapter including plates arranged at an angle to a horizontal plane of the blender tub's upper opening.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a depiction of the blender system consistent with certain embodiments of the present disclosure.

FIG. 2a is a top-down detailed view of a multi-tiered dispersion adapter consistent with certain embodiments of the present disclosure.

FIG. 2b is a perspective view of the multi-tiered dispersion adapter of FIG. 2a.

FIGS. 3a, 3b, 3c are detailed views of a multi-tiered dispersion adapter consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

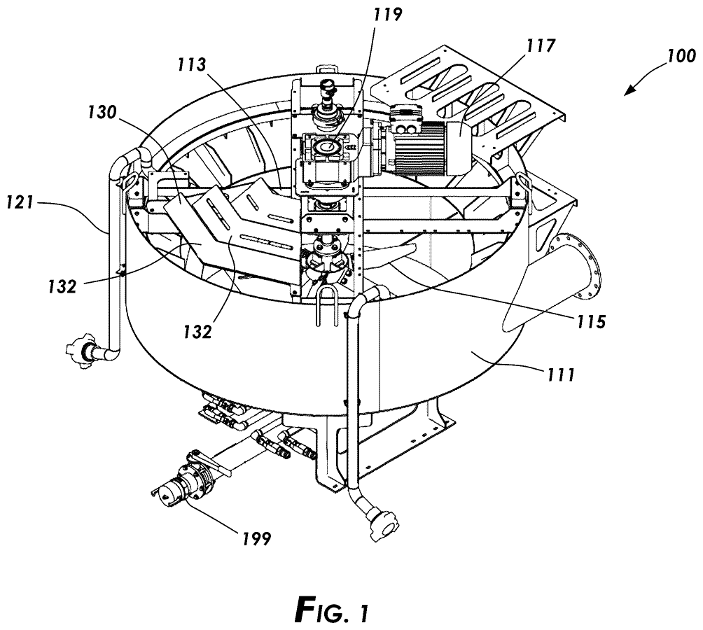

FIG. 1 depicts blender system 100. Blender system 100 may be used to prepare fluids for use in wellbore operations including stimulation operations such as hydraulic fracturing operation. For the purposes of this disclosure and without any intent to limit the scope of this disclosure, the fluids prepared by blender system 100 are referred to herein as a slurry made up of ingredients, chemicals, products, and base fluids as understood in the art such as, for example and without limitation, friction reducer, high viscosity friction reducer, guar or synthetic gel, inhibitors, PH buffers, proppant (such as sand), and biocides.

Blender system 100 may include blender tub 111, which defines mixing chamber 113. Blender tub 111 may be a vessel into which ingredients, chemicals, products, and base fluids may be introduced and mixed. In some embodiments, blender system 100 may include one or more blender paddles 115 positioned within mixing chamber 113 and rotatably driven by tub paddle motor 117. In some embodiments, tub paddle motor 117 may be an electric motor. In some embodiments, tub paddle motor 117 may operatively couple to blender paddles 115 via paddle gearbox 119. Blender paddles 115 may, as they rotate within mixing chamber 113, agitate and mix the ingredients, chemicals, products, and base fluids introduced thereinto to prepare the slurry. In some embodiments, blender tub 111 may include outlet 199 positioned at the base of blender tub 111. In some embodiments, base fluids may be introduced into blender tub 111 via supply pipe 121 coupled thereto.

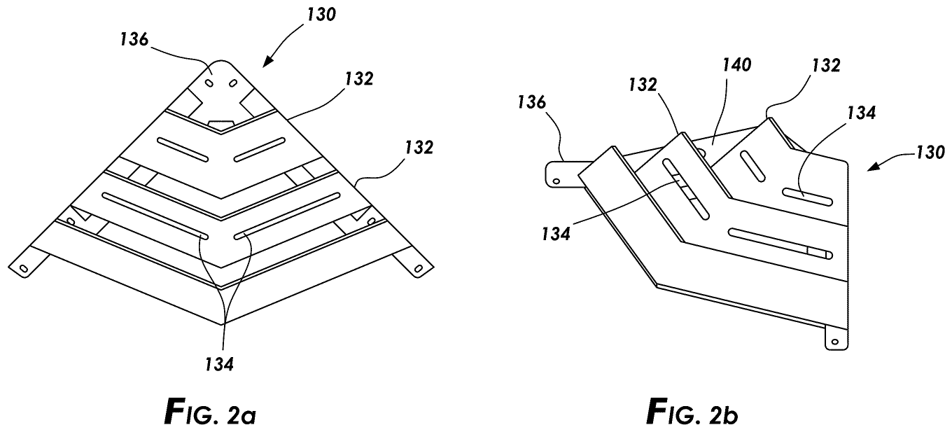

In addition, blender system 100 may include multi-tiered dispersion adapter 130 positioned within blender tub 111, as shown in FIGS. 1, 2, and 3. Multi-tiered dispersion adapter 130 includes plates 132 arranged at angles to fit within blender tub 111 and are connected to one another. Plates 132 may be connected to each other using such non-limiting examples as weldments and bolting. Plates 132 may include holes/slits 134. Holes/slits 134 may change the dispersion of proppant and the proppant's mix with ingredients in the slurry. Multi-tiered dispersion adapter 130 assists in the dispersion of proppant in a variety of blender tub 111 applications, without adding powered components.

Plates 132 may be positioned on mounting fixture 136. Mounting fixture 136 may be positioned within blender tub 111. Mounting fixture 136 is manufactured and installed so that plates 132 achieve a 35-75 degree angle of repose, as measured from the horizontal plane of blender tub 111's upper opening (where proppant is delivered). Each plate 132 in this iteration is fixed; however, each plate 132 may be adjustable to encourage dispersion based on proppant delivery method. Specifically, mounting fixture 136 may be installed perpendicular to a vertical axis of blender paddles 115, as shown in the Figures. In other embodiments, mounting fixture 136 may be installed at an angle from 90 to 60 degrees from the vertical axis of blender paddles 115. Further, mounting fixture 136 may include angled slots 140 in which plates 132 may be positioned.

Proppant may be delivered via a conveyor system, in which proppant is transported towards the tub at a height set above the tub and dropped into the tub at varying volumes and rates of speed. Multi-tiered dispersion adapter 130 may be constructed of any suitable material, such as for example, steel. Holes are punched in multi-tiered dispersion adapter 130 so that other layers of material may be added to plate 132 to further prevent bridging and increase flow. Added material may vary based on the type of proppant and its properties. Added material may be a screen or mesh. Bridging is understood to mean the buildup of slurry on each plate 132.

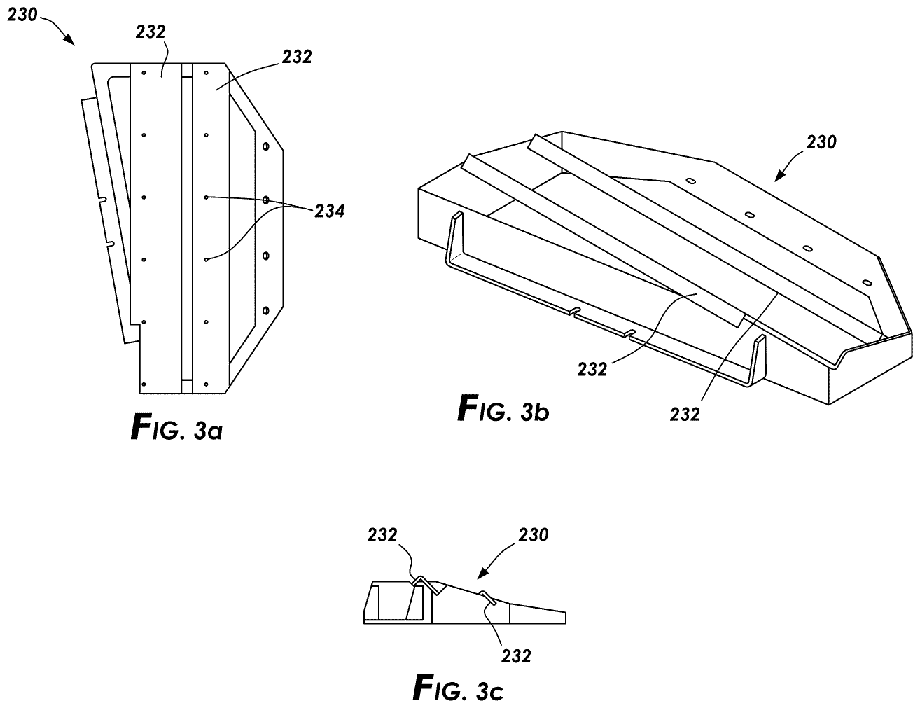

FIGS. 3a, 3b, and 3c depict an alternative embodiment of multi-tiered dispersion adapter 230. Multi-tiered dispersion adapter 230 includes plates 232 arranged at angles to fit within blender tub 111 and are connected to one another. Plates 232 may be connected to each other using such non-limiting examples as weldments and bolting. Plates 232 may include holes/slits 234. Holes/slits 234 may change the dispersion of proppant and the proppant's mix with ingredients in the slurry.

As the proppant goes into blender tub 111, multi-tiered dispersion adapters 130 and 230 may disperse proppant for better suspension in the liquids in blender tub 111.

In certain embodiments, the spread of proppant and slurry across multi-tiered dispersion adapter 130, and the angle of plates 132, affect the rate at which the slurry moves in, about and through the tub as the slurry moves towards the outlet. Multi-tiered dispersion adapter 130 may increase dispersion from 50-125% as compared to dispersion of proppant into blender tub 111 via traditional methods such as a nozzle.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A blender system comprising:
a blender tub, the blender tub defining a mixing chamber, an interior, and an upper opening;
one or more blender paddles positioned within the mixing chamber;
a multi-tiered dispersion adapter positioned within the blender tub, the multi-tiered dispersion adapter including plates arranged at an angle to a horizontal plane of the blender tub's upper opening.

2. The blender system of claim 1, wherein the plates are connected to one another.

3. The blender system of claim 2, wherein the plates are connected to one another via weldments or bolting.

4. The blender system of claim 2, wherein the plates are not powered.

5. The blender system of claim 1, wherein the plates include holes or slits.

6. The blender system of claim 5, wherein the holes or slits in the plates are adapted to change a dispersion of proppant within ingredients in a slurry within the blender tub.

7. The blender system of claim 1, wherein the plates are mounted on a mounting fixture.

8. The blender system of claim 7, wherein the mounting fixture is positioned in the interior of the blender tub.

9. The blender system of claim 8, wherein the mounting fixture is mounted perpendicular to a vertical axis of the one or more blender paddles.

10. The blender system of claim 1, wherein the multi-tiered dispersion adapter includes slots.

11. The blender system of claim 10, wherein the plates are positioned within the slots.

12. The blender system of claim 11, wherein the slots are angled.

13. The blender system of claim 1, wherein the plates are positioned at a 35-75 degree angle of repose with respect to a horizontal plane of the upper opening.

14. The blender system of claim 1, wherein the plates are fixed.

15. The blender system of claim 1, wherein the plates are adjustable.

16. The blender system of claim 1, wherein the multi-tiered dispersion adapter is constructed of steel.

17. The blender system of claim 16, wherein the multi-tiered dispersion adapter further includes screen or mesh attached to plates.

18. The blender system of claim 1, wherein the one or more blender paddles are operatively coupled to one or more motors.

19. The blender system of claim 1, wherein the multi-tiered dispersion adapter is constructed of steel.
